(19) United States
(12) Patent Application Publication
(10) Pub. No.: US 2021/0025220 A1
(43) Pub. Date: Jan. 28, 2021

(54) Up and Over Window

(71) Applicant: CAPOFERRI SERRAMENTI S.P.A., Adrara San Martino BG (IT)

(72) Inventors: Francesco CAPOFERRI, ADRARA San MARTINO (BERGAMO) (IT); Sergio CAPOFERRI, ADRARA San MARTINO (BERGAMO) (IT)

(21) Appl. No.: 16/647,336

(22) PCT Filed: Sep. 13, 2018
(86) PCT No.: PCT/IB2018/056993

§ 371 Date: Mar. 13, 2020

(30) Foreign Application Priority Data
Sep. 15, 2017 (IT) 102017000103279

(51) Int. Cl. E06B 3/50; E05D 15/58

(52) U.S. Cl. CPC E06B 3/5018; E05D 2015/586; E05Y 2900/148; E05D 15/582

(57) ABSTRACT

The invention relates to a window 20 comprising a steady frame 22, a movable frame 24, and an actuator 26 for moving the movable frame 24. The steady frame mainly extends in a plane σ, comprises at least one plate 220 which mainly extends in a plane τ perpendicular to the plane σ, the plate 220 comprises a main track 222 and an auxiliary track 224. The movable frame extends predominantly in a plane π perpendicular to the plane τ and comprises: at least one pivot 242 defining a rotation axis X, perpendicular to the plane τ and parallel to the planes σ and π, the pivot 242 being conformed so as to be able to be slidingly held in the main track; at least one pin 244 which is rigidly mounted on the movable frame, which extends in a direction parallel to axis X, which is spaced from axis X, and which is conformed so as to be slidingly held in the auxiliary track. Furthermore, the actuator is suitable for imposing to the pivot a slide movement along the main track; the slide movement of the pivot along the main track imposes to the pin a slide movement along the auxiliary track; the auxiliary track is shaped so as to impose to the pin a rotation around axis X during the slide movement of the pin along the auxiliary track; and the pin is supported by a crank 246 rigidly mounted on the pivot 242.

The present invention relates to an up and over window, in particular an up and over window for particularly valuable areas such as terraces and orangeries.

In a well-known way, it is possible to value some internal areas or areas which are adjacent to the buildings, providing them with large glazed surfaces. In this way, those who remain inside these glazed areas are given the opportunity to enjoy the visual and emotional contact of the surrounding area. In addition, the arrangement of glazed closures means that even areas adjacent or outside the building such as porches, terraces, verandas, orangeries and the like can be comfortably inhabited even in the presence of harsh temperatures and/or adverse weather conditions.

At the same time, however, the need is felt, in the presence of mild temperatures and/or pleasant weather conditions, to open these areas as much as possible, in such a way that those remaining therein have the feeling of being really outdoors.

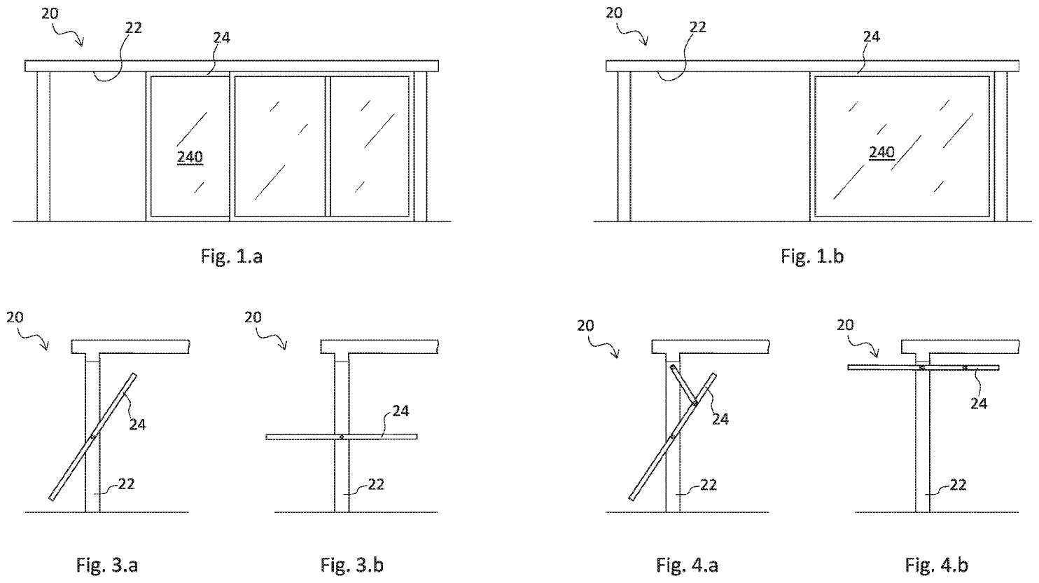

To this end, various solutions have been proposed, since the normal casement windows, when open, determine a large encumbrance of the space inside the area. The main known solutions are briefly described below with reference to FIGS. 1 to 4.

A first solution is that of sliding windows. These windows have the advantage of being able to reach considerable dimensions, keeping the possibility of being opened and closed easily. Moreover, in an open configuration, these windows do not create any encumbrance. For these reasons sliding windows are widely used, especially in the case of large windows. However, the sliding windows always maintain the closure of a relevant portion (usually half) of the overall glazed surface. By way of example, FIG. 1 show a horizontal sliding window, however the same drawback is also found in the vertical sliding windows.

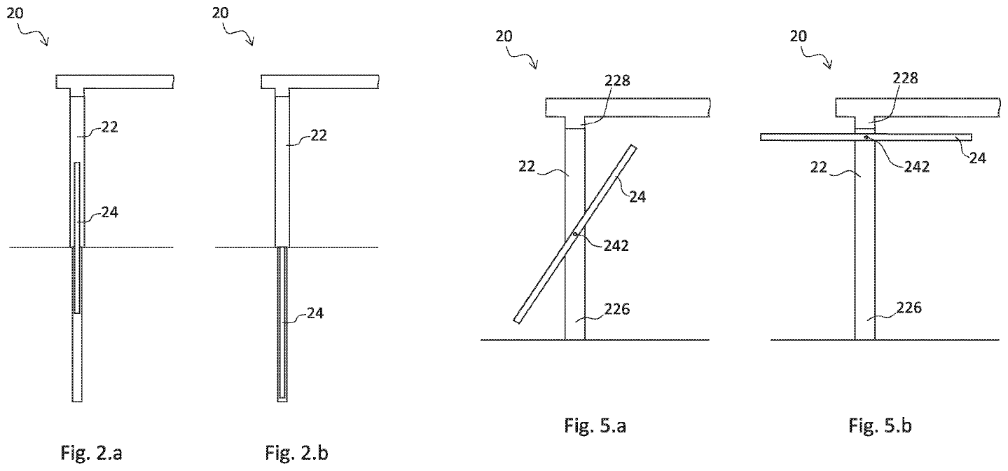

One solution for this drawback is that of the so-called retractable sliding windows. According to this known solution, the window is held in a special compartment formed in the structure adjacent to the steady frame. In the case of the areas considered in the present application, the structure is reduced to the minimum and often consists only of columns and beams. For this reason, the compartments to accommodate the retractable sliding windows can only be obtained in the floor, as can also be seen in the scheme of FIG. 2. This solution therefore requires the complete availability of the property underlying the window, as well as being particularly demanding from the installation point of view.

Another type of window which is suitable to be realized even having large dimensions, is the so-called pivoted window, wherein the window is opened by rotating the latter around a barycentric axis. This allows the movement of even very heavy windows with limited effort. The vertically pivoted windows occupy essentially the same space of the normal casement windows. On the contrary, the horizontally pivoted windows leave the surface near the floor completely free, however they are arranged horizontally at half the height of the opening, thus constituting a considerable encumbrance. This encumbrance, represented schematically in FIG. 3, as well as being inconvenient, can also be dangerous when it is at a height of less than about 2 meters. Considering the dimensions usually adopted for the windows, such an event is very probable and therefore the pivoted windows cannot be easily used in these cases.

Finally, there is a last type of structure to consider, the so-called “up and over” or canopy door structure, represented schematically in FIG. 4. This solution combines a rotation of the window, similar to the horizontally pivoted window, with an upward translation of the pivot. This composition of movements causes, at the end of the opening, the window to be in a horizontal position at the maximum opening height (FIG. 4.b). This canopy solution of the known type involves the use of a pair of service rods which make the structure particularly unpleasant from an aesthetic point of view. The canopy solution, in fact, has almost no use in windows for residential areas of particular value, but thanks to its practical features and minimum encumbrances it is widely adopted for technical rooms and garages in particular.

Therefore, the object of the present invention is to overcome the drawbacks of the known art highlighted above.

In particular, an object of the present invention is to provide a window which allows a total opening of the glazed surface without the need to provide adjacent compartments and without creating encumbrances.

Furthermore, an object of the present invention is to provide an aesthetically pleasing window suitable for installation in areas of particular value.

This aim and these tasks are achieved by means of a window according to claim 1.

To better understand the invention and appreciate its advantages, some of its exemplifying and non-limiting embodiments are described below with reference to the accompanying drawings, wherein:

FIG. 1.a schematically shows a front view of a first type of window according to the prior art, in a partially opened configuration;

FIG. 1.b shows the window of FIG. 1.a, in a fully opened configuration;

FIG. 2.a schematically shows a side view of a second type of window according to the prior art, in a partially opened configuration;

FIG. 2.b shows the window of FIG. 2.a, in a fully opened configuration;

FIG. 3.a schematically shows a side view of a third type of window according to the prior art, in a partially opened configuration;

FIG. 3.b shows the window of FIG. 3.a, in a fully opened configuration;

FIG. 4.a schematically shows a side view of a fourth type of window according to the prior art, in a partially opened configuration;

FIG. 4.b shows the window of FIG. 4.a, in a fully opened configuration;

FIG. 5.a schematically shows a side view of a window according to the invention, in a partially opened configuration;

FIG. 5.b shows the window of FIG. 5.a, in a fully opened configuration;

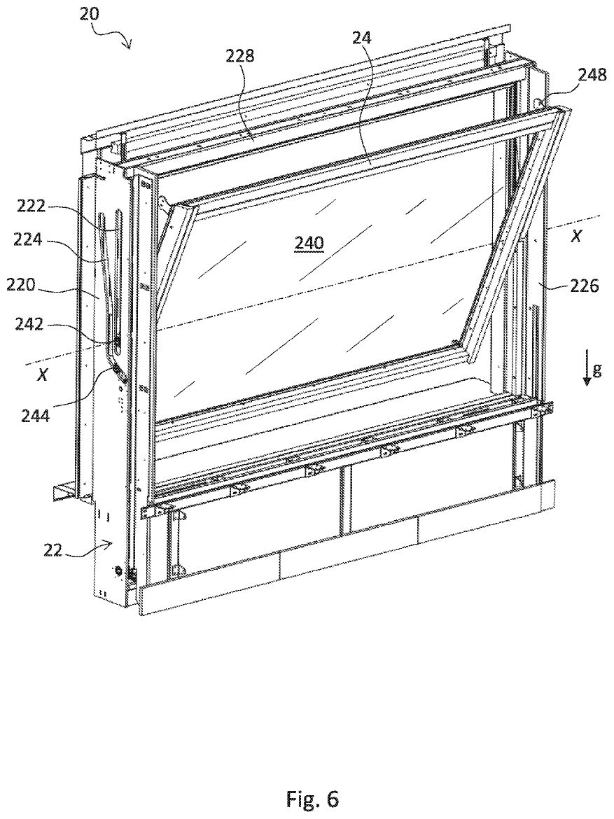

FIG. 6 shows a perspective view of a window according to the invention, in a partially opened and isolated configuration;

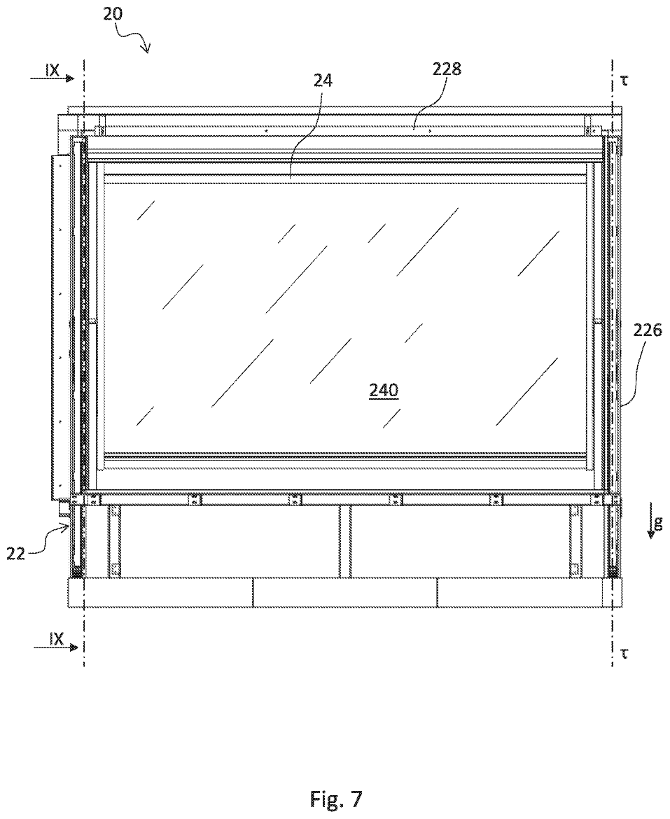

FIG. 7 shows a front view of the window of FIG. 6;

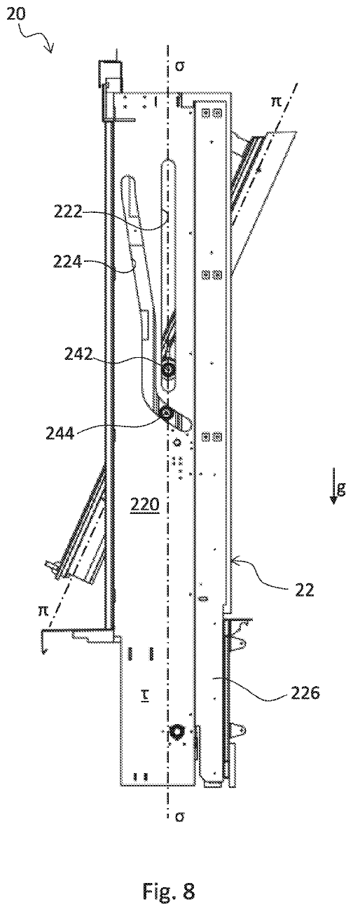

FIG. 8 shows a side view of the window of FIG. 6;

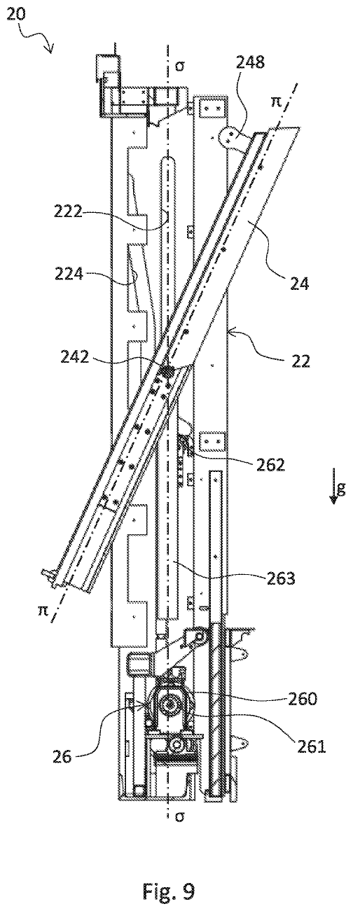

FIG. 9 shows a sectional view according to the line IX-IX of FIG. 7;

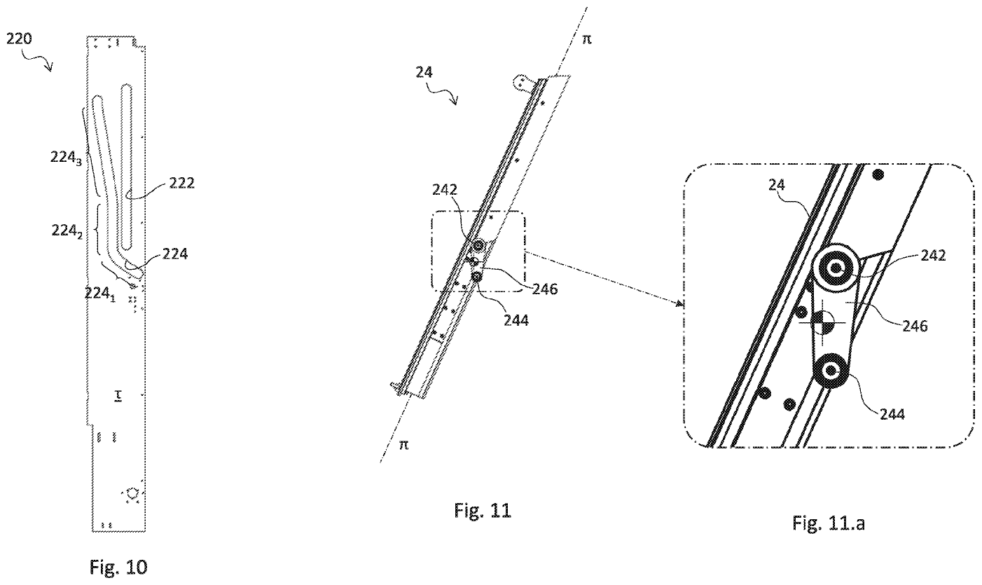

FIG. 10 shows a side view of a plate comprised in the steady frame of the window according to the invention;

FIG. 11 shows a side view of the movable frame of the window according to the invention;

FIG. 11.a shows an enlarged view of a detail of FIG. 11;

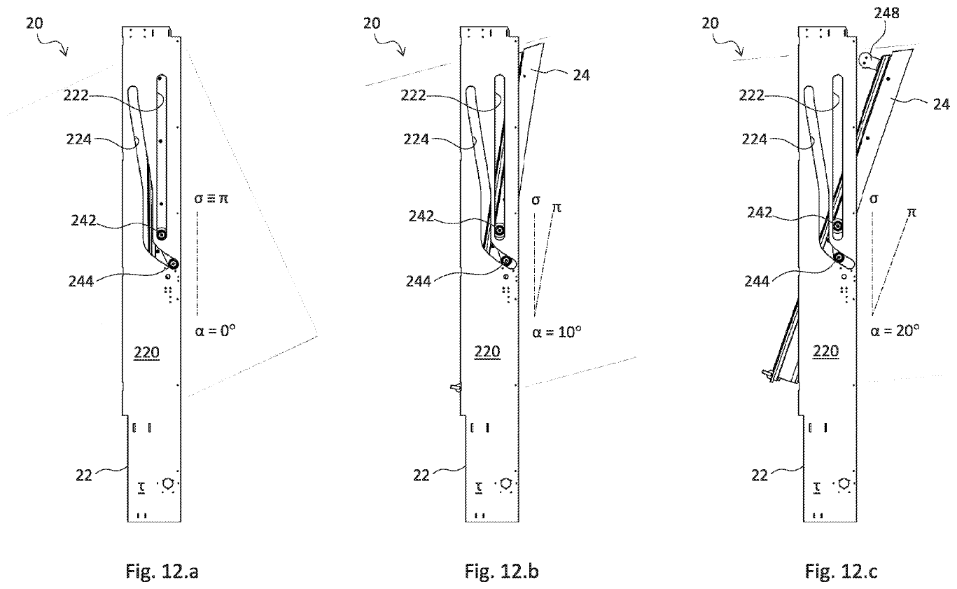

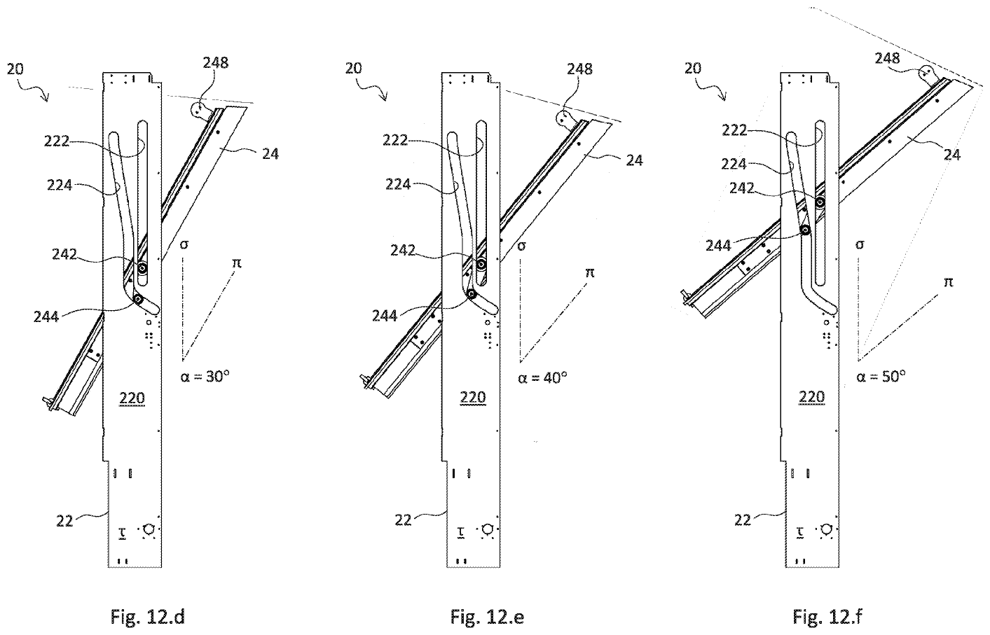

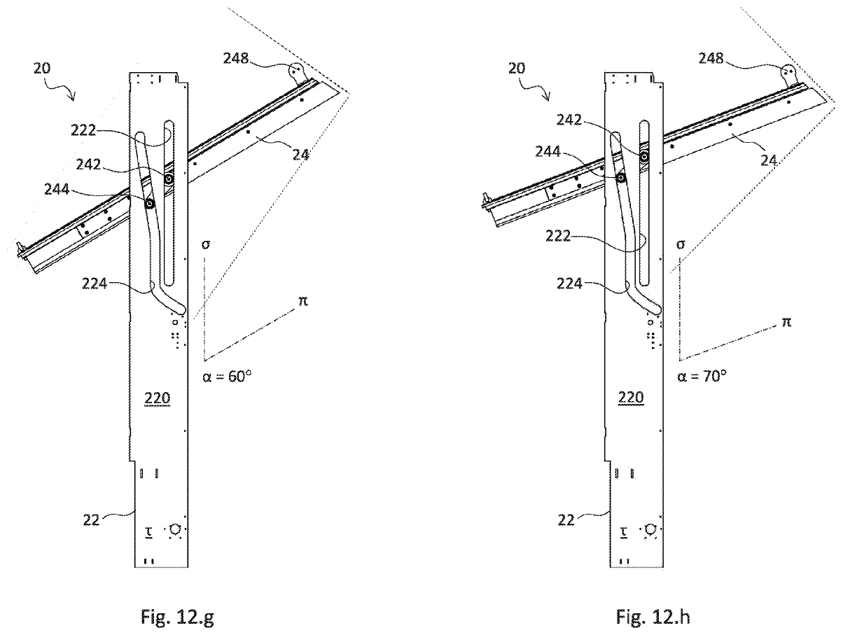

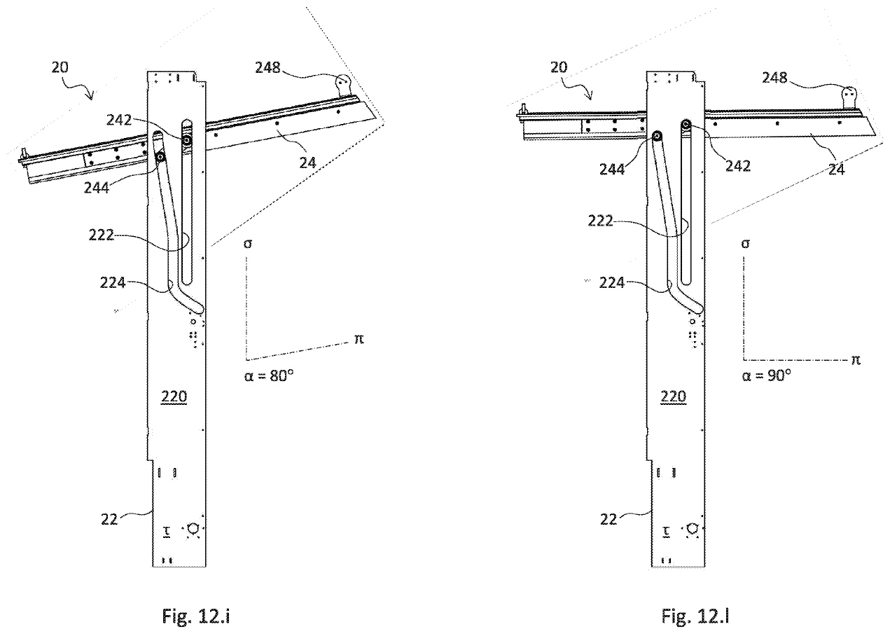

FIG. 12.a shows a side view of a window according to the invention, in a fully closed configuration;

FIG. 12.b shows a view similar to that of FIG. 12.a, wherein the window according to the invention is opened by 10°;

FIG. 12.c shows a view similar to that of FIG. 12.b, wherein the window according to the invention is opened by 20°;

FIG. 12.d shows a view similar to that of FIG. 12.c, wherein the window according to the invention is opened by 30°;

FIG. 12.e shows a view similar to that of FIG. 12.d, wherein the window according to the invention is opened by 40°;

FIG. 12.f shows a view similar to that of FIG. 12.e, wherein the window according to the invention is opened by 50°;

FIG. 12.g shows a view similar to that of FIG. 12.f, wherein the window according to the invention is opened by 60°;

FIG. 12.h shows a view similar to that of FIG. 12.g, wherein the window according to the invention is opened by 70°;

FIG. 12.i shows a view similar to that of FIG. 12.h wherein the window according to the invention is opened by 80°;

FIG. 12.l shows a view similar to that of FIG. 12.i, wherein the window according to the invention is fully opened; and

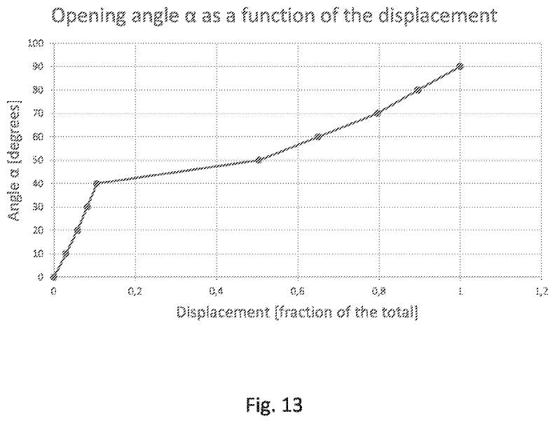

FIG. 13 shows a possible plot of the variation of the opening angle as a function of the displacement.

In the context of the present discussion, some terminological conventions have been adopted in order to make reading easier and smoother.

Since the window according to the invention is intended to be used in the presence of gravity acceleration g, it is intended that the latter uniquely defines the vertical direction. Likewise, it is understood that, based on gravity acceleration g, the terms “high”, “higher”, “above” and the like are defined unequivocally, with respect to the terms “low”, “lower”, “below” and the like.

The invention relates to a window 20 comprising

a steady frame 22, a movable frame 24, and an actuator 26 for moving the movable frame 24;

wherein
the steady frame 22 mainly extends in a plane σ, comprises at least one plate 220 which mainly extends in a plane τ perpendicular to the plane σ, the plate 220 comprising a main track 222 and an auxiliary track 224;
the movable frame 24 mainly extends in a plane π perpendicular to the plane τ and comprises
at least one pivot 242 which defines a rotation axis X perpendicular to the plane τ and parallel to the planes a and 7, the pivot 242 being conformed so as to be able to be slidingly held in the main track 222;
at least one pin 244 which is rigidly mounted on the movable frame 24, which extends in a direction parallel to axis X, which is spaced from axis X in a direction perpendicular to plane π, and which is conformed so as to be slidingly held in the auxiliary track 224;
   and wherein:
the actuator 26 for moving the movable frame 24 is suitable for imposing to the pivot 242 a sliding along the main track 222;
the sliding of the pivot 242 along the main track 222 imposes to the pin 244 a sliding along the auxiliary track 224; and
the auxiliary track 224 is shaped so as to impose to the pin 244 a rotation about the axis X during the sliding of the pin 244 along the auxiliary track 224;
   and wherein the pin 244 is supported by a crank 246 rigidly mounted on the pivot 242.

Here and below, the term “axial” means the direction of any straight line parallel to the axis X; the term “radial” means the direction of any half-line having its origin on the axis X and perpendicular thereto; the term “circumferential” means the direction of any circumference being centered on the axis X and lying on a plane perpendicular to it; the term “tangential” means the direction of any straight line tangent to a circumference defined above.

As the skilled person can understand, the steady frame 22 is defined “steady” in an intuitive manner and relating to the window 20 itself. This does not exclude that the steady frame 22 can be mounted on an overall movable structure, such as a movable home, a ship or the like. Usually, the steady frame 22 comprises two side struts 226 and two crossbeams 228.

Preferably, the movable frame 24 can move between a fully closed position, wherein the window 20 is in a fully closed configuration, and a fully opened position, wherein the window 20 is in a fully opened configuration. Preferably, when the window 20 is in the fully closed configuration, the plane π of the movable frame 24 and the plane a of the steady frame 22 coincide or are parallel. When the window 20 switches to a partially opened configuration, the plane π of the movable frame 24 forms an angle α with the plane σ of the steady frame 22. Finally, when the window 20 is in the fully opened configuration, the angle α takes the maximum value allowed by the specific structure of the window 20. In the embodiments shown in the accompanying figures, the angle α can be up to 90° (see FIG. 12.l). Hereinafter, the angle α is also called the opening angle because it provides an indication of the opening degree of the window 20.

Preferably, the plane τ, wherein the plate 220 mainly extends, is a vertical plane. This configuration, although not strictly necessary, is preferable in most of the embodiments. Moreover, in the embodiments shown in the attached figures, also the plane σ of the steady frame 22 is a vertical plane, perpendicular to the plane τ. Even this configuration, even if it is the most widespread, is not necessary. For example, in the case where the window 20 was inserted in a non-vertical wall, such as for example a sloping roof, the plane σ of the steady frame 22 may not be vertical.

In the most common case wherein the τ plane is vertical, the rotation axis X is horizontal, as well as the pivot 242 and the pin 244.

Preferably, the steady frame 22 comprises two plates 220, parallel to each other, placed at the two opposite sides of the steady frame 22 and each comprising a main track 222. The plates 220 are at least partially specular to each other, meaning that at least the respective main tracks 222 match perfectly together if the two plates 220 are brought together with a rigid translation in the axial direction. In this case, the movable frame 24 is mounted between the two plates 220 and comprises two pins 242, each of which is slidingly held in a respective main track 222. The presence of two pins 242 is particularly advantageous because it implies that the movable frame 24 is supported and slid along the main tracks 222 by a symmetrical system of forces.

Preferably, each of the two plates 220 comprises a respective auxiliary track 224. Also in this case the plates 220 are specular, meaning that also the auxiliary tracks 224 match perfectly together if the two plates 220 are brought together with a rigid translation along the axial direction. In this case the movable frame 24 comprises two pins 244, each of which is slidingly held in a respective auxiliary track 224. The presence of two pins 244 is particularly advantageous because it implies that the movable frame 24 is supported and rotated about the axis X by a symmetrical system of forces.

As already mentioned above, the pivot 244 is rigidly mounted on the movable frame 24, extends parallel to the axis X and is spaced apart from it. The pin 244 therefore allows to apply a moment, or torque, with respect to the axis X to the movable frame 24. In other words, a tangential force applied to the pin 244 creates a moment that causes the pin 244 to rotate around the axis X. Furthermore, the rotation of the pin 244 about the axis X is also transmitted to the movable frame 24, since the pivot 244 is rigidly mounted on the movable frame 24.

In the present invention (see the attached figures), the pin 244 is supported by a crank 246 rigidly mounted on the pivot 242. In particular, the crank 246 extends radially from the pivot 242 to a certain axial distance from the movable frame 24. This particular configuration allows all the members for the movement of the movable frame 24 to be enclosed in the side strut 226 of the steady frame 22, providing only a slot which allows the movement of the pivot 242, and in particular of its portion which is the closest to the movable frame 24 from an axial point of view. In this way, the main track 222, the auxiliary track 224, the portion of the pivot 242 which is held in the main track 222, the crank 246, the pin 244, and the actuator 26 are all housed inside the side strut 226 of the steady frame 22 and are concealed during the normal operation of the window 20.

As mentioned above, the main track 222 slidingly holds the pivot 242 and the auxiliary track 224 slidingly holds the pin 244. In the embodiment shown in the figures, the main track 222 and the auxiliary track 224 take the shape of grooves or open slots through the plate 220. In this same embodiment, the pivot 242 and the pin 244 comprise an axial end which is housed inside the respective slot. Each axial end, both the one of the pivot 242 and the one of the pin 244, is constrained by the side walls of the respective slot and can only slide along the slot itself.

As the skilled person can well understand, other embodiments of the tracks 222 and 224 are also possible. For example, the tracks can be made by means of linear guides on which carriages bound to the pivot 242 and to the pin 244 run.

Preferably, the contact between the pivot 242 and the main track 222 is made in such a way as to minimize the friction between the respective surfaces during the movement of the movable frame 24 for opening the window 20. For this purpose, it is possible to adopt one or more solutions, per se known to the skilled person, also in order to satisfy specific needs which can also be very different in different situations. A solution for reducing the sliding friction may be that of making or at least partially covering the pivot 242 and/or the main track 222 with a material having a low coefficient of friction, for example with polytetrafluoroethylene (PTFE). Another solution to reduce the sliding friction can be that of providing a suitable lubrication between the surfaces coming into contact to each other during movement. A further solution may be that of providing rolling bodies in the contact zone between the surfaces of the pivot 242 and of the main track 222.

The main track 222 determines the trajectory of the main movement of the movable frame, i.e. the movement of the rotation axis X which is typically the same movement of the center of mass of the movable frame 24, unless a rigid translation occurs. In most embodiments of the invention, including the embodiments shown in the accompanying figures, the main movement of the movable frame 24 is directed vertically. In other words, the movable frame 24 is lifted during the opening of the window 20 and is lowered during the closure of the window 20.

The main track 222 preferably follows the shortest path between the position assumed by the pivot 242 when the window 20 is in the fully closed configuration, and the position assumed by the pivot 242 when the window 20 is in the fully opened configuration. Preferably, therefore, the main track 222 has a rectilinear development.

In some particular cases, it is possible to impose different developments to the main track 222. For example, where, for specific requirements, the movable frame 24 must move following a particular trajectory, for example to avoid collisions with foreign bodies which cannot be removed.

The auxiliary track 224 acts as a linear cam and determines the secondary movement of the movable frame 24, typically the movement of the movable frame 24 about the rotation axis X during its translation. In most embodiments of the invention, including the embodiments shown in the accompanying figures, the secondary movement of the movable frame is a rotation, equal to the opening angle α, about the horizontal axis X. In other words, during the opening of the window 20, the movable frame 24 is lifted and at the same time it rotates increasing the amplitude of the angle α. According to the embodiments shown in the figures, starting from the fully closed configuration of the window 20, wherein the plane π is substantially vertical (FIG. 12.a), the rotation imposed to the movable frame 24 by the auxiliary track 224 during the opening movement brings the plane π to assume a substantially horizontal orientation in the fully opened configuration (FIG. 12.l). Vice versa, during the closure of the window 20, the movable frame 24 is lowered and at the same time it rotates, thus decreasing the amplitude of the angle α. In the embodiments of the accompanying figures, starting from the fully opened configuration of the window 20, wherein the plane π is substantially horizontal (FIG. 12.l), the rotation imposed to the movable frame 24 by the auxiliary track 224 during the closure movement brings the plane π to assume again the substantially vertical orientation in the fully closed configuration (FIG. 12.a). As already mentioned above, the actuator 26 is suitable for imposing the sliding along the main track 222 to the pivot 242. In light of the above, it will therefore be clear to the skilled person that the actuator 26 must be configured in such a way as to be able to develop a sufficient force to overcome the resistances. As already disclosed above, in most cases the main movement to be imposed to the movable frame 24 is a lift. In these cases, the actuator 26 must develop a force which is at least sufficient to overcome the weight force of the movable frame 24 and of everything it comprises (see below for a more detailed disclosure of the elements which may be included in the movable frame 24). Furthermore, also the secondary movement of the movable frame 24 (i.e. the rotation about the axis X), as well as the internal frictions of the mechanism, generate respective resistances which must be overcome by the actuator 26.

As the skilled person can understand, in the sizing of the actuator 26 it is preferable to consider also other forces which can occasionally oppose the movement of the movable frame 24. For example, in some particular circumstances it is possible that wind and/or snow determines a considerable load for moving the movable frame 24.

The actuator 26 can take different shapes according to the specific requirements. In some embodiments which prefer lightness and simplicity, the actuator 26 may comprise a mechanism operated manually by the user, for example by means of a crank which drives an endless screw and a gear rack. In other cases, wherein the window 20 is generally heavier and more refined, the actuator 26 can comprise a motorized mechanism which does not require any effort on the user for opening and closing the window 20.

According to the embodiment of the attached figures (see in particular FIG. 9), the actuator 26 comprises an electric motor 260 which rotates a first gear 261. A chain (not shown) engages the first gear 261 and a second gear 262. The two gears 261 and 262 are preferably arranged such that a rectilinear portion of the chain which engages them has a length which is greater than or equal to that of the main track 222. Preferably, the rectilinear portion of the chain engaging the two gears 261 and 262 is also oriented like the main track 222. This configuration, although not strictly necessary, is largely preferable compared to other solutions. According to this embodiment, a rigid rod 263 has a first end fixed to the chain and a second end in contact with the pivot 242.

When the motor 260 is operated to open the window 20, the chain rotates in such a way as to push the rigid rod 263 which in turn pushes the pivot 242 along the main track 222, imparting to the movable frame the main translation movement of the axis X. The movement of the pivot 242 necessarily implies the movement of the pin 244 along the auxiliary track 224 which acts as a linear cam and which, as described above, gives rise to the secondary movement of the movable frame 24, i.e. to the rotation about the axis X.

As the skilled person can understand, the shape of the auxiliary track 224 is that determining the rotation of the movable frame 24 around the axis X. The exact shape of the auxiliary track 224 must be defined on a case-by-case basis at the design stage, in order to meet the specific requirements. Some considerations on the specific auxiliary track 224 used in the embodiment of the attached figures, with particular reference to FIGS. 12 and 13, are reported below. In this case it can be seen that the shape of the auxiliary track 224 imposes to the movable frame 24 a large portion of the rotation in the first phases of the displacement. More specifically, FIG. 12 represent subsequent configurations assumed by the window 20 according to the invention, passing from the fully closed configuration (FIG. 12.a wherein α=0°) to the fully opened configuration (FIG. 12.l wherein α=90°). FIG. 13 represents the plot, obtained by interpolated points, of the variation of the opening angle α with respect to the displacement fraction of the pivot 242 along the main track 222. Considering the left portion of FIG. 13 and comparing to each other the FIGS. 12.a, 12.b, 12.c, 12.d and 12.e it is possible to see that 4/9 of the rotation of the movable frame 24 take place on just the 10% of the displacement of the pivot 242 along the main track 222. This particular rotation law is particularly advantageous in view of the specific shape of the window 20 since, immediately imposing a considerable rotation to the movable frame 24, it allows to free the latter with respect to the encumbrance of the crosspiece 228 of the steady frame 22 and from possible adjacent structures. Once the movable frame 24 is free, it can be lifted without any risk of impact with other fixed structures.

As can be seen in the accompanying figures, the auxiliary track 224 assumes a shape which is approximately similar to the side profile of a long-handle digging shovel or of a hockey stick. As can be seen in particular in FIG. 10, the lower portion 2241 of the auxiliary track 224 is that which is similar to the shovel blade or to the hockey stick blade. This lower portion 2241 is the most inclined with respect to the main track 222. The inclination of the lower portion 2241 imposes the marked initial rotation which occurs substantially between FIG. 12.a and FIG. 12.e. The same rotation corresponds to the first section, which is very inclined, of the plot of FIG. 13, the section comprised between about 0% and about 10% of the displacement. Subsequently, the auxiliary track 224 has an intermediate portion 2242, which is similar to the part of the handle of the shovel or to the hockey stick farthest from the user. This intermediate portion 2242 is substantially rectilinear and almost parallel to the main track 222. Being almost parallel to the main track 222, this portion imposes a negligible rotation to the movable frame 24. The intermediate portion 2242 corresponds to the movement which the movable frame 24 performs between FIG. 12.e and FIG. 12.f; the same movement corresponds to the intermediate section, which is very slightly inclined, of the plot of FIG. 13, the section comprised between about 10% and about 50% of the displacement. Finally, the auxiliary track 224 has a higher portion 2243, which is similar to the part of the handle of the shovel or to the hockey stick closest to the user. This higher portion 2243 is again inclined with respect to the main track 222, although much less with respect to the lower portion 2241. The inclination of the higher portion 2243 imposes the final rotation which occurs substantially between FIG. 12.f and FIG. 12.l. The same rotation corresponds to the last section, which is inclined, of the plot of FIG. 13, the section comprised between about 50% and 100% of the displacement.

As can be seen in particular in FIG. 10, the auxiliary track 224 is arranged in such a way as to start at the bottom right of the main track 222 and in such a way as to terminate on the left, near the upper end thereof. Other reciprocal arrangements of the two tracks 222 and 224 are possible by adjusting the position and the distance of the pin 244 with respect to the pivot 242.

The particular reciprocal arrangement of the two tracks 222 and 224, which has been chosen for the embodiment of FIG. 10, is particularly advantageous because it allows to limit the horizontal dimension of the plate 220. In fact, as can be seen in the accompanying figures, the plate 220 has a horizontal size (i.e., the size perpendicular to the plane σ of the steady frame 22) which allows it to be easily integrated into a standard sized side strut 226.

As the skilled person may understand, the movable frame 24 preferably comprises a panel 240. In most embodiments, the panel 240 is transparent, for example made of one or more sheets of glass, and/or of transparent polymer, such as polycarbonate. Alternatively, the panel can be blind, for example made of wood, metal sheet, laminate, MDF (Medium-Density Fibreboard) or other suitable materials for the realization of doors and windows. Furthermore, the panel can be perforated, for example made with a grate, a grid or a mosquito net.

In the embodiments shown in the accompanying figures, the movable frame 24 also comprises a structure 248 suitable for supporting a curtain. Because of the particular opening movement, the window 20 according to the invention does not cooperate optimally with traditional curtains, neither hanging inside nor hanging outside. The most advantageous possibility to apply a curtain, preferably a roller blind, is to mount it directly on the movable frame 24.

Preferably, the position of the pivot 242, which defines the axis X, is defined as follows. Considering the movable frame 24 arranged vertically (as in FIG. 12.a) and equipped with all the provided components for its operating life (panel 240, structure 248 for the curtain, curtain etc.), the axis X is preferably placed above the center of mass of the movable frame 24. In the embodiment of the attached figures, this position of the axis X and the specific configuration of the tracks 222 and 224, cause the moment generated by the weight force of the movable frame 24 with respect to the pivot 242 to be always oriented in the same direction in any position assumed by the movable frame 24 during its opening movement. With particular reference to FIGS. 11 and 11.a, wherein the position of the center of mass of the movable frame 24 is shown, and to the subsequent FIG. 12, wherein some successive positions assumed by the movable frame 24 during opening are shown, it may be noted that the moment generated by the weight force of the movable frame 24 is always counterclockwise, from the fully opened configuration to the fully closed configuration.

The fact that the moment, although varying in intensity due to the variation of the arm, always maintains the same direction causes the pin 244 to tend always to rest against the same side wall of the auxiliary track 224. In the specific case, since the moment is counterclockwise, the pin 244 tends to rest always on the right-side wall of the auxiliary track 224.

Of course, this does not exclude that the pin 244 can possibly rest also on the other side wall (the left one, in the specific case) of the auxiliary track 224, but this only occurs if an abnormal force, although provided, acts on the movable frame 24, such as wind pressure or the people or things resting thereon.

If, on the other hand, the moment generated by the weight force changes direction in correspondence of a given position assumed by the movable frame 24 during opening, in that position the pin 244 would tend to move against the other side wall. This change of support of the pin 244 is usually accompanied by a short oscillation before the stabilization on the new support. This small oscillation, although not implying any danger, can be uncomfortable in terms of noise and feeling of precariousness which, even if without any reasons, can be felt by the user.

As the skilled person can understand, the invention allows to overcome the drawbacks highlighted above with reference to the known art.

In particular, the present invention provides a window which allows a total opening of the glazed surface without the need to provide adjacent compartments and without creating encumbrances.

Furthermore, the present invention provides an aesthetically pleasing window suitable for installation in areas of particular value.

It is clear that the specific features are described in relation to various embodiments of the invention with exemplifying and non-limiting intent. Obviously, a person skilled in the art may make further modifications and variations to this invention, in order to meet contingent and specific requirements. For example, the technical features described in connection with an embodiment of the invention may be extrapolated from it and applied to other embodiments of the invention. Such modifications and variations are, however, contained within the scope of the invention, as defined by the following claims.

1. A window (20) comprising:
a steady frame (22), a movable frame (24), and an actuator (26) for moving the movable frame (24);
wherein
the steady frame (22) mainly extends in a plane σ, the steady frame (22) comprises at least one plate (220) which mainly extends in a plane τ perpendicular to the plane σ, the plate (220) comprising a main track (222) and an auxiliary track (224);
the movable frame (24) mainly extends in a plane π perpendicular to the plane τ and comprises
at least one pivot (242) which defines a rotation axis X perpendicular to the plane τ and parallel to the planes σ and π, the pivot (242) being conformed so as to be able to be slidingly held in the main track (224);
at least one pin (244) which is rigidly mounted on the movable frame (24), which extends in a direction parallel to the axis X, which is spaced from the axis X, and which is conformed so as to be able to be slidingly held in the auxiliary track (224);
wherein
the actuator (26) for moving the movable frame (24) is suitable for imposing to the pivot (242) a slide movement along the main track (222);
the slide movement of the pivot (242) along the main track (222) imposes to the pin (244) a slide movement along the auxiliary track (224); and
the auxiliary track (224) is shaped so as to impose to the pin (244) a rotation around axis X during the slide movement of the pin (244) along the auxiliary track (224); and
wherein the pin (244) is supported by a crank (246) rigidly mounted on the pivot (242).

2. The window (20) according to claim 1, wherein the movable frame (24) can move between a position of complete closure, where the plane π of the movable frame (24) coincides with or is parallel to the plane σ of the steady frame (22), and a position of complete opening.

3. The window (20) according to claim 2, wherein the steady frame (22) comprises two plates (220), parallel the one to the other, placed at two opposed sides of the steady frame (22) and each comprising a main track (222), wherein the two main tracks (222) perfectly correspond to one another if the two plates (220) are pulled together by means of a rigid translation along axis X and wherein the movable frame (24) is mounted between the two plates (220) and comprises two pivots (242), each of them being slidingly held in a respective main track (222).

4. The window (20) according to claim 1, wherein the steady frame (22) comprises two plates (220), parallel the one to the other, placed at two opposed sides of the steady frame (22) and each comprising an auxiliary track (224), wherein the two auxiliary tracks (224) perfectly correspond to one another if the two plates (220) are pulled together by means of a rigid translation along axis X and wherein the movable frame (24) is mounted between the two plates (220) and comprises two pins (244), each of them being slidingly held in a respective auxiliary track (224).

5. The window (20) according to claim 1, wherein the main track (222) has a rectilinear development.

6. The window (20) according to claim 5, wherein the crank (246) radially extends from the pivot (242) at a certain axial distance from the movable frame (24).

7. The window (20) according to claim 6, wherein the steady frame (22) comprises two side struts (226) and two crossbeams (228) and wherein the main track (222), the auxiliary track (224), the portion of the pivot (242) held in the main track (222), the crank (246), the pin (244) and the actuator (26) are housed inside one side strut (226) of the steady frame (22) and are concealed during the normal operation of the window (20).

8. The window (20) according to claim 1, wherein the movable frame (24) comprises a panel (240).

9. The window (20) according to claim 1, wherein the movable frame (24) comprises a structure (248) suitable for supporting a curtain.

10. The window (20) according to claim 1, wherein, considering the movable frame (24) arranged vertically, the pivot (242) is placed above the center of mass of the movable frame (24).

11. The window (20) according to claim 1, wherein the steady frame (22) comprises two plates (220), parallel the one to the other, placed at two opposed sides of the steady frame (22) and each comprising a main track (222), wherein the two main tracks (222) perfectly correspond to one another if the two plates (220) are pulled together by means of a rigid translation along axis X and wherein the movable frame (24) is mounted between the two plates (220) and comprises two pivots (242), each of them being slidingly held in a respective main track (222).

12. The window (20) according to claim 1, wherein the crank (246) radially extends from the pivot (242) at a certain axial distance from the movable frame (24).

13. The window (20) according to claim 1, wherein the steady frame (22) comprises two side struts (226) and two crossbeams (228) and wherein the main track (222), the auxiliary track (224), the portion of the pivot (242) held in the main track (222), the crank (246), the pin (244) and the actuator (26) are housed inside one side strut (226) of the steady frame (22) and are concealed during the normal operation of the window (20).
